(19) United States
(12) Patent Application Publication
(10) Pub. No.: US 2010/0328177 A1
(43) Pub. Date: Dec. 30, 2010

(54) ANTENNA ELEMENT AND ARRAY OF ANTENNA ELEMENTS

(75) Inventors: Dean Kemp, Glasgow (GB); Michael Philippakis, Surrey (GB); Neil Williams, I, West Sussex (GB)

Correspondence Address: PEPPER HAMILTON LLP, ONE MELLON CENTER, 50TH FLOOR, 500 GRANT STREET, PITTSBURGH, PA, 15219, US

(73) Assignee: ITI SCOTLAND LIMITED, Glasgow (GB)

(21) Appl. No.: 12/682,590

(22) PCT Filed: Oct. 13, 2008
(86) PCT No.: PCT/GB2008/003474

§ 371 Date: Sep. 14, 2010

(30) Foreign Application Priority Data
Oct. 12, 2007 (GB) 0720025.6

(51) Int. Cl. H01Q 1/50; H01Q 19/26; H01Q 21/06; H01Q 3/24; H01Q 1/42

(52) U.S. Cl. 343/834; 343/860; 343/893; 343/876; 343/872

(57) ABSTRACT

There is provided an antenna element for use in an ultra wideband network, the antenna element comprising a radiating element, for radiating signals over a range of frequencies in response to a signal received at a feed point; and a frequency shaping device located near the feed point of the radiating element for acting as a broad-banding device for the radiating element. A plurality of antenna elements may be formed into an antenna array.

### TECHNICAL FIELD OF THE INVENTION

The invention relates to an antenna element, and in particular relates to an antenna element for use in an ultra wideband network which maximises signal strength and reduces interference.

### BACKGROUND TO THE INVENTION

Ultra-wideband is a radio technology that transmits digital data across a very wide frequency range, 3.1 to 10.6 GHz. By spreading the RF energy across a large bandwidth the transmitted signal is virtually undetectable by traditional frequency selective RF technologies. However, the low transmission power limits the communication distances to typically less than 10 to 15 meters.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 10-15 m of one another.

FIG. 1 shows the arrangement of frequency bands in a Multi Band Orthogonal Frequency Division Multiplexing (MB-OFDM) system for ultra-wideband communication. The MB-OFDM system comprises fourteen sub-bands of 528 MHz each, and uses frequency hopping every 312.5 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organised into five band groups, four having three 528 MHz sub-bands, and one band group having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

The antenna arrangements used in ultra-wideband systems are usually omni-directional, meaning that radio signals are emitted in all directions from an active radiating element, or elements, and a number of omni-directional antennas have been devised that support operation over the full UWB bandwidth of 3.1 to 10.6 GHz.

This can lead to the data transfer from one device in a particular environment (for example a home) interfering with the data transfer from another device. There is therefore a need for directionality in such high speed communication networks.

In future systems, which are targeted at very high data rate applications, there are benefits in using a number of higher gain elements, each of which covers a specific angular sector. Although travelling wave elements can be used which offer the wide bandwidth required by an ultra-wideband network, an array of such elements is relatively large.

An antenna can also comprise a choke element that is configured to isolate the operation of an antenna from adverse diffraction effects, for example due to a ground plane. Such choke components act to suppress current flowing along a metallic structure.

It is therefore an object of the invention to provide an antenna element and an antenna arrangement for use in an ultra-wideband system that overcomes the problems with the above conventional arrangements.

### SUMMARY OF THE INVENTION

The inventors have found that by configuring a frequency shaping device in a certain manner in relation to a radiating element, the frequency shaping device can act in a broad-banding effect on the signal being emitted by the radiating element, rather than choking the signal.

According to a first aspect of the invention, there is provided an antenna element for use in an ultra wideband network, the antenna element comprising a radiating element, for radiating signals over a range of frequencies in response to a signal received at a feed point; and a frequency shaping device located near the feed point of the radiating element, the frequency shaping device being configured to have a profile that acts as a broad-banding device for the radiating element.

Preferably, the frequency shaping device comprises a plurality of individual frequency shaping portions located near the feed point.

Preferably, the plurality of individual frequency shaping portions comprise concentrically arranged surfaces.

Preferably, the plurality of concentrically arranged surfaces have respective heights, the height of a concentrically arranged surface being measured in a direction that is perpendicular to a substrate of the antenna element.

Preferably, the plurality of concentrically arranged surfaces have different heights.

Preferably, the radiating element comprises an omni-directional monopole.

Preferably, the antenna element further comprises a reflector component positioned relative to the radiating element such that RF signals radiated by the radiating element are reflected in a predetermined direction.

Preferably, the reflector component comprises a parasitic element.

Preferably, the parasitic element is in the form of a monopole.

In accordance with a second aspect of the invention, there is provided an antenna array for use in an ultra wideband network, the antenna array comprising a plurality of antenna elements, each element being as described above.

Preferably, the plurality of antenna elements are arranged such that each element serves a respective angular sector.

Preferably, the plurality of antenna elements are arranged in a ring.

Preferably, the antenna array further comprises a switch connected to each of the plurality of antenna elements, for providing a signal received at an input to a selected one or more of the plurality of antenna elements.

Preferably, the operation of the switch is controlled by a control signal received at a control input to the switch.

Preferably, the antenna array further comprises a radome positioned so as to enclose each of the plurality of antenna elements. The radome may be provided for safety and/or aesthetic reasons.

### BRIEF DESCRIPTION OF THE DRAWINGS

The invention will now be described, by way of example only, with reference to the following drawings, in which:

FIG. 1 shows the arrangement of frequency bands in a Multi-Band Orthogonal Frequency Division Multiplexing (MB-OFDM) system for ultra-wideband communication;

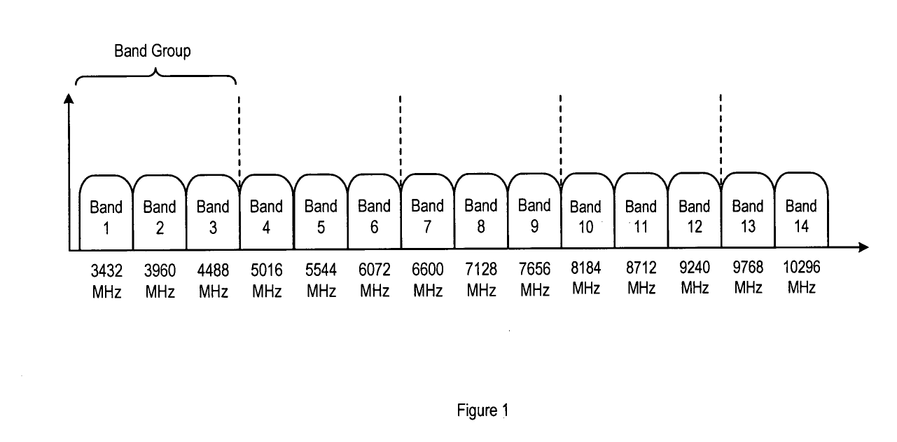

FIG. 2 shows a cross-section of an antenna element having a frequency shaping device in accordance with the invention;

FIG. 3 shows an alternative frequency shaping device in accordance with the invention;

FIG. 4 is a block diagram of an antenna arrangement in accordance with the invention; and

FIG. 5 is a perspective view of an antenna arrangement in accordance with a first embodiment of the invention;

FIG. 6 is a perspective view of an antenna arrangement in accordance with a further embodiment of the invention;

FIG. 7 is a perspective view of an antenna arrangement in accordance with a further embodiment of the invention; and

FIG. 8 is a perspective view of an antenna arrangement in accordance with a further embodiment of the invention.

### DETAILED DESCRIPTION OF THE PREFERRED EMBODIMENTS

Although the invention will be described further herein as relating to use in an ultra wideband network, it will be appreciated that the invention can be adapted for use in other types of wireless communications network.

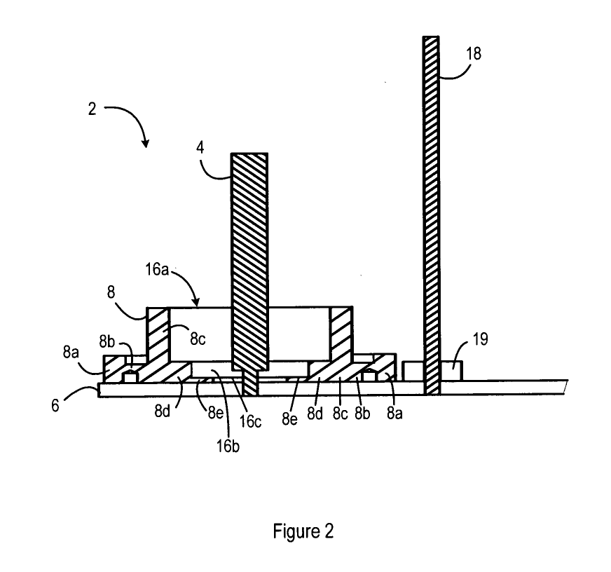

FIG. 2 shows a cross-section of an antenna element 2 in accordance with the invention. The element 2 comprises a radiating element 4 in the form of an omni-directional monopole, which is arranged so that it is substantially perpendicular to a substrate 6.

The antenna element 2 also comprises a frequency shaping device 8 that is designed to “adapt” alternating currents in the feed line of the radiating element 4 from the DC supply lines. The frequency shaping device 8 is formed with a predetermined profile such that the frequency shaping device 8 affects the fields radiated from the radiating element 4 over a large range of frequencies. As a result, the frequency shaping device 8 acts as a broad-banding device for the radiating element 4 which provides a good return loss characteristic over large bandwidths, and in particular over bandwidths used in an ultra wideband network.

In a preferred embodiment, the frequency shaping device 8 comprises a plurality of frequency shaping portions 8a, 8b, 8c, 8d and 8e, the frequency shaping portions 8a, 8b, 8c, 8d and 8e effectively forming individual surfaces that are arranged around the feed point of the radiating element 4. The plurality of frequency shaping portions 8a, 8b, 8c, 8d and 8e preferably comprise concentric surfaces and have different heights from the substrate 6. The plurality of frequency shaping portions 8a, 8b, 8c, 8d and 8e can be separate sections or an unitary device. For example, when formed as an unitary device, the plurality of frequency shaping portions 8a, 8b, 8c, 8d and 8e may be formed using separate concentric grooves, with the portions intersecting adjacent grooves having different heights. Alternatively, the unitary section can be formed such that a stepped change in height is seen from one portion of the frequency shaping device to the next.

It will be appreciated that the frequency shaping device can have fewer, or a greater number of portions than the example shown in FIG. 2. In addition, two or more of the frequency shaping portions can have an equal height, provided that at least two of the frequency shaping portions have a different height.

The different heights of the plurality of frequency shaping portions 8a, 8b, 8c, 8d and 8e act to change the bandwidth characteristics of the signal being radiated by the radiating element 4. The plurality of frequency shaping portions 8a, 8b, 8c, 8d and 8e therefore act to enhance the bandwidth of the antenna element 2.

The frequency shaping device is preferably located near the base of the radiating element, for example mounted on the structure 6.

Although the frequency shaping device is shown as having a planar base at the bottom, with the frequency shaping portions having different heights extending above this planar base, it is noted that the orientation of the device can be changed, such that the planar base is provided at the top of the frequency shaping device, with the frequency shaping portions having different heights extending below this planar top.

The radiating element 4 is held in place around the frequency shaping device 8 by a support structure 16. In one embodiment, the support structure 16 comprises sections 16a, 16b and 16c. The sections 16a, 16b, 16c can be separate sections or one unitary structure. In an alternative embodiment the support structure 16 comprises just one section, for example section 16a, with air gaps provided in the areas identified by sections 16b and 16c. Other embodiments may comprise different configurations of the sections 16a, 16b, 16c.

The support structure 16 may be formed from a dielectric material. In one embodiment, the support structure comprises a dielectric material having a permittivity similar to that of air. It will be appreciated, however, that the permittivity of the dielectric material may be chosen according to the desired characteristics of the antenna.

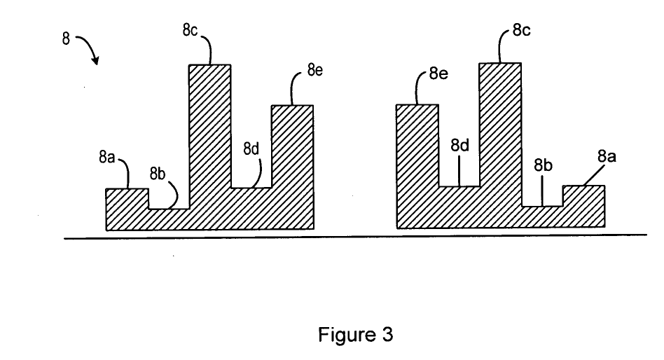

FIG. 3 shows an alternative frequency shaping device 8 in accordance with the invention. The frequency shaping device 8 is similar to that shown in FIG. 2, although in this embodiment, the individual frequency shaping portion 8e, which is nearest to the radiating element 4, is larger (higher) than the neighbouring frequency shaping portion 8d.

As mentioned above, it will be appreciated by a person skilled in the art that it is not necessary for the frequency shaping device 8 to include exactly five individual frequency shaping portions, and that more or less individual frequency shaping portions can be provided. It will also be appreciated that the profile of the frequency shaping device, i.e. formed from the individual frequency shaping portions 8a, 8b, 8c, etc., may vary according the particular frequency characteristics of a given antenna arrangement.

Furthermore, as mentioned above it will be appreciated that the frequency shaping device 8 may be a single unitary structure, or can be made up of separate individual frequency shaping device structures. A frequency shaping device 8 in the form of a single unitary structure may be fabricated using milling or machining techniques to provide the plurality of frequency shaping surfaces.

In a further aspect of the invention, the antenna element 2 comprises a reflector component 18 that is attached to the substrate 6. The reflector component 18 is positioned relative to the radiating element 4 such that, when the radiating element 4 is activated and radiates an RF signal, the reflector component 18 reflects the incident RF signal back towards the radiating element 4. The result is that the RF signals are propagated over a desired sector away from the reflector component 18.

In a preferred embodiment, the reflector component 18 comprises a parasitic element in the form of a monopole. In alternative embodiments, the reflector component 18 can comprise any structure that is capable of reflecting incident RF signals in a predetermined direction. Furthermore, the cross-sectional shape of the reflector component 18 can be circular, rectangular, square, triangular or any other shape. The cross-sectional shape of the reflector component can be chosen according to a desired beam pattern of the reflected signal. In one embodiment the reflector component 18 has a support structure 19 at its base.

It is noted that the relative height of the radiating element 4 and the reflector component 18 may differ to that shown in the Figures.

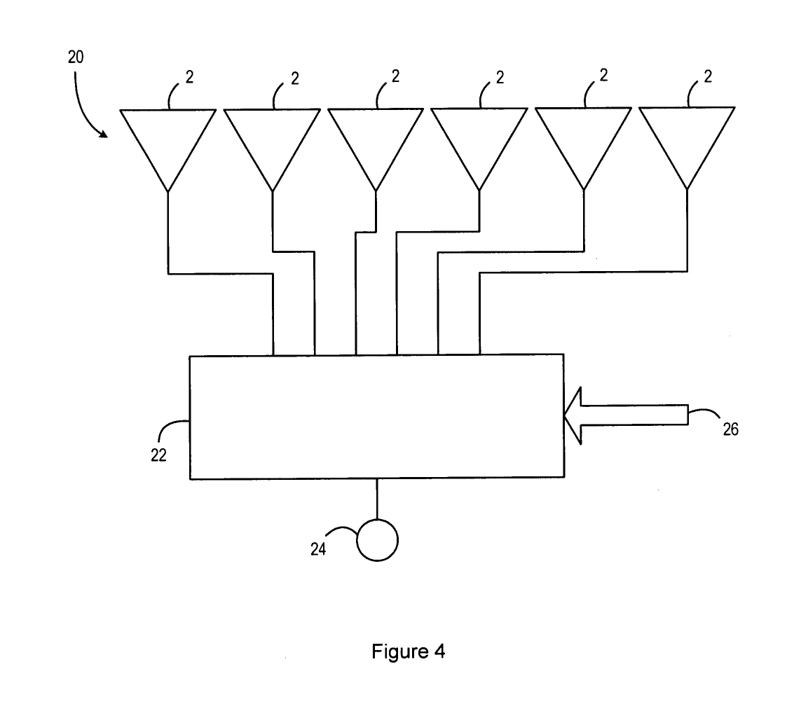

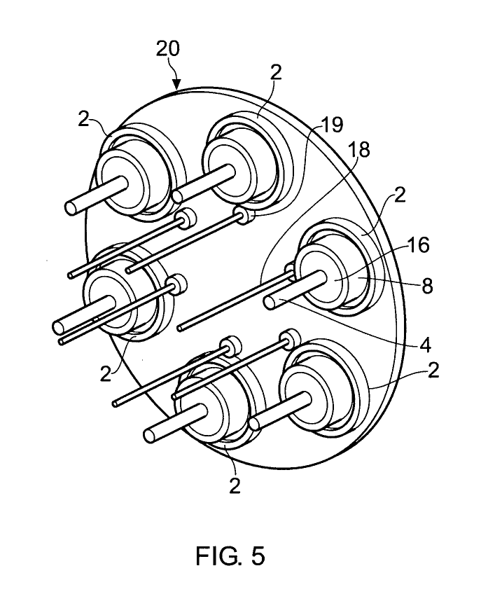

In a further aspect of the invention, as illustrated in FIGS. 4 and 5, an antenna array 20 is provided that comprises a plurality of the antenna elements 2 described above. The antenna elements 2 are arranged such that each element 2 serves a respective angular sector, which means that, by activating a particular element 2, an RF signal can be radiated in a desired direction. Preferably, the elements 2 are configured in a ring, although it will be appreciated that other configurations are possible.

In a preferred embodiment, an RF switch 22, as described in FIG. 4, is provided which directs an RF signal received at an input 24 to a particular antenna element 2, depending on the direction in which the signal is to be transmitted. The operation of switch 22 is controlled by a control signal received at a control input 26. It will be apparent to a person skilled in the art how the switch may be controlled, and this aspect is therefore not covered in the present application.

The arrangement in FIGS. 4 and 5 provides an antenna array 20 that has up to 360 degrees azimuthal coverage.

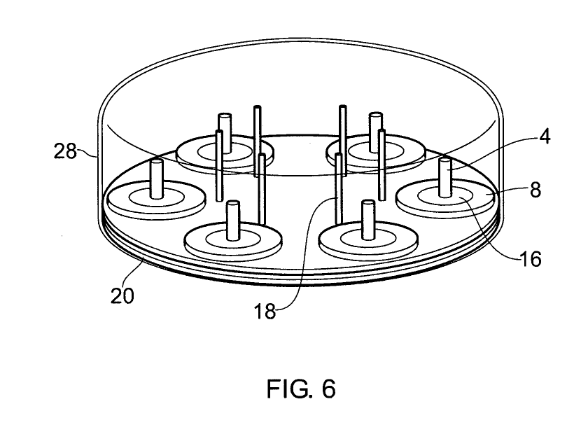

The antenna array 20 may also be provided with a radome 28, as shown, for example, in FIGS. 6, 7 and 8, to protect the antenna elements 2, and in particular the radiating elements 4 and reflector components 18. The radome may be opaque in nature in order to enhance the aesthetic design of the antenna arrangement for domestic environments.

FIGS. 6, 7 and 8 show alternative implementations of an antenna array 20 in accordance with the invention, and in particular show alternative ways of supporting the antenna elements 2 in the array 20.

The embodiment of FIG. 6 is similar to that of FIG. 5, although each frequency shaping device 8 has been simplified such that the visible surface of the frequency shaping device 8 is uniform, rather than a series of concentric circles as shown in FIG. 5. This has the advantage of reducing the manufacturing costs of the antenna array. The frequency shaping device 8 of FIG. 6 comprises one or more stepped surfaces (not shown) under the support structure 16, thus forming individual frequency shaping portions 8d, 8e that are similar to frequency shaping portions 8d and 8e of FIG. 2. It will be appreciated that the number of frequency shaping portions under the support structure 16 can differ from that shown in FIG. 2. For example, the frequency shaping device 8 in the embodiment of FIG. 6 may have more individual frequency shaping devices under the support structure 16, thereby compensating for the fact that the visible portion only has one frequency shaping device. It is also noted that, in the embodiment of FIG. 6, the reflector components 18 do not comprise a support structure 19 as shown in FIG. 5.

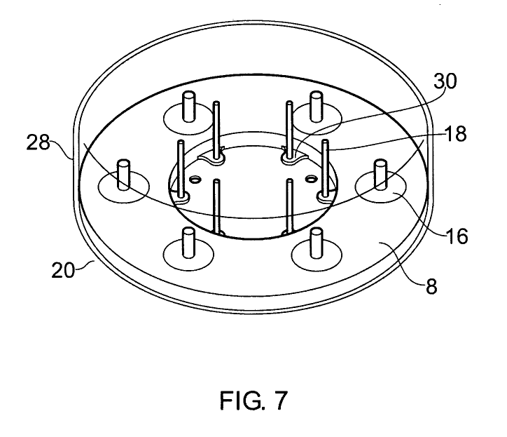

FIG. 7 shows an alternative embodiment in which the frequency shaping devices associated with the radiating elements 4 are integrated into a unitary frequency shaping device 8. The unitary frequency shaping device 8 comprises one or more stepped surfaces (not shown) under each support structure 16, thus forming individual frequency shaping portions 8d, 8e that are similar to frequency shaping portions 8d and 8e of FIG. 2. As above, it will be appreciated that the number of frequency shaping portions can differ from that shown in FIG. 2. The embodiment of FIG. 7 shows the reflector components 18 being supported by protrusions 30 extending from the frequency shaping device 8, rather than having a support structure 19 as shown in FIGS. 2 and 5.

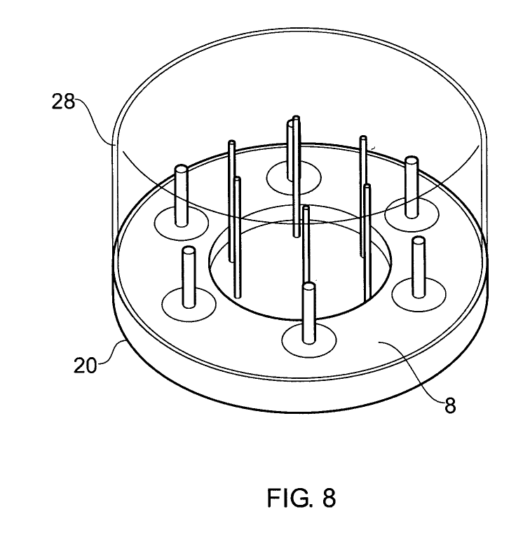

The embodiment of FIG. 8 is similar to FIG. 7, but having the reflector component 18 supported directly by the base 20, without the support structure 19 of FIG. 5.

It will be appreciated that various features may be interchanged between the embodiments described above. For example, the embodiment of FIG. 5 may have the support structures 19 removed such that the reflector components 18 are mounted directly on the base 20, and vice versa.

The frequency shaping device 8 may be made from a number of suitable materials. For example, the frequency shaping device may be made from a metal or alloy, for example aluminium, that is machined to form the desired profile. The frequency shaping device material can then be plated, for example using a nickel flash. The frequency shaping device may be further plated with silver to improve its electrical properties. Other suitable materials may also be used to form the frequency shaping device, for example, brass or gold. According to a further embodiment, the frequency shaping device may be machined from a non-metal, for example plastic, and then coated with a metal coating. This may be advantageous in certain situations in order to reduce manufacturing costs.

There is therefore provided an antenna element and an antenna array for use in an ultra-wideband system that overcomes the problems with conventional antenna arrangements.

1. An antenna element for use in an ultra wideband network, the antenna element comprising:
a radiating element, for radiating signals over a range of frequencies in response to a signal received at a feed point; and
a frequency shaping device located near the feed point of the radiating element, the frequency shaping device being configured to have a profile that acts as a broad-banding device for the radiating element.

2. An antenna element as claimed in claim 1, wherein the frequency shaping device comprises a plurality of individual frequency shaping portions.

3. An antenna element as claimed in claim 2, wherein the plurality of individual frequency shaping portions comprise concentric surfaces.

4. An antenna element as claimed in claim 2, wherein the plurality of individual frequency shaping portions have respective heights, the height of an individual frequency shaping portion being measured in a direction that is perpendicular to a substrate of the antenna element.

5. An antenna element as claimed in claim 2, wherein at least two of the individual frequency shaping portions have a different height.

6. An antenna element as claimed in claim 1, wherein the frequency shaping device is located near a feed point of the radiating element.

7. An antenna element as claimed in claim 6, wherein the frequency shaping device is mounted on a substrate supporting the radiating element.

8. An antenna element as claimed in claim 1, further comprising a support structure for supporting the radiating element.

9. An antenna element as claimed in claim 8, wherein the support structure is located above one or more of the plurality of individual frequency shaping portions.

10. An antenna element as claimed in claim 8, wherein the support structure comprises a dielectric material.

11. An antenna element as claimed in claim 10, wherein the dielectric material has a permittivity similar to air.

12. An antenna element as claimed in claim 1, wherein the radiating element comprises an omni-directional monopole.

13. An antenna element as claimed in claim 1, further comprising:
a reflector component positioned relative to the radiating element such that RF signals radiated by the radiating element are reflected in a predetermined direction.

14. An antenna element as claimed in claim 13, wherein the reflector component comprises a parasitic element.

15. An antenna element as claimed in claim 14, wherein the parasitic element is in the form of a monopole.

16. An antenna element as claimed in claim 15, further comprising a support structure for supporting the reflector component.

17. An antenna element as claimed in claim 1, wherein the frequency shaping device is formed from a metal or metal alloy.

18. An antenna element as claimed in claim 1, wherein the frequency shaping device is formed from a non-metal.

19. An antenna element as claimed in claim 14, wherein the frequency shaping device is coated with a metal or alloy coating.

20. An antenna element as claimed in claim 1, wherein the frequency shaping device is formed from an unitary member.

21. An antenna array for use in an ultra wideband network, the antenna array comprising:
a plurality of antenna elements, each element being as claimed in any preceding claim.

22. An antenna array as claimed in claim 21, wherein the plurality of antenna elements are arranged such that each element serves a respective angular sector.

23. An antenna array as claimed in claim 22, wherein the plurality of antenna elements are arranged in a ring.

24. An antenna array as claimed in claim 21, wherein the frequency shaping devices of the respective antenna elements are configured to form a single frequency shaping device.

25. An antenna array as claimed in claim 21, further comprising:
a switch connected to each of the plurality of antenna elements, for providing a signal received at an input to a selected one or more of the plurality of antenna elements.

26. An antenna array as claimed in claim 25, wherein the operation of the switch is controlled by a control signal received at a control input to the switch.

27. An antenna array as claimed in claim 21, further comprising a radome positioned so as to enclose each of the plurality of antenna elements.

28. An antenna array as claimed in claim 27, wherein the radome is opaque.

29. (canceled)

30. (canceled)
